(19) United States
(12) Patent Application Publication
(10) Pub. No.: US 2026/0121668 A1
(43) Pub. Date: Apr. 30, 2026

(54) LOW-LATENCY DETERMINATION OF OPTIMAL LOW-POWER MODES (LPMS) OF INACTIVE CIRCUITS IN AN INTEGRATED CIRCUIT (IC) AND RELATED POWER MANAGEMENT METHODS

(71) Applicant: QUALCOMM Incorporated, San Diego, CA (US)

(72) Inventors: Changqing Ye, San Marcos, CA (US); Lakshmi Narayana Panuku, Hyderabad (IN); Anil Kumar Lamichhane, Hyderabad (IN)

(21) Appl. No.: 18/928,267

(22) Filed: Oct. 28, 2024

(51) Int. Cl. H04B 1/04; H04B 1/16; H04W 52/22

(52) U.S. Cl. CPC H04B 1/04; H04B 1/1607; H04W 52/226

(57) ABSTRACT

Some logic circuits in an IC may have periods of inactivity, such as when the functions they provide are not needed, but they continue to consume power. In an exemplary IC, a power manager determines that a logic circuit is in an inactive state, employs a lookup table circuit to determine an optimal low-power mode (LPM) for the logic circuit based on an anticipated duration of the inactive state, and causes the circuit to enter the optimal LPM. Determining an optimal LPM from a lookup table circuit minimizes the latency of the LPM determination. Determining an optimal LPM may include comparing net energy consumptions of LPMs with different rates of power consumption. In some examples, the power manager provides at least one of a circuit identifier, a circuit frequency, and a memory interface frequency to the lookup table circuit and receives the optimal LPM.

### TECHNICAL FIELD

The technology of the disclosure relates generally to power conservation in integrated circuits (IC) and, more particularly, to optimizing power savings in circuits entering an inactive state.

### BACKGROUND

A system-on-chip (SoC) is an integrated circuit (IC) with circuits providing a variety of functions. During normal operation, there may be periods in which some of the functions of an SoC are not used, and the circuits that provide those functions are inactive. A power manager is employed in the SoC to monitor the circuits and, during periods of inactivity, transition them to a low-power mode (LPM) to reduce energy consumption in the IC until the functions provided by the circuits are to be used again. There may be different types of LPMs available for a particular circuit, where each type of LPM provides a different level of power savings and a corresponding entry/exit cost, which refers to energy and time consumed to enter and exit the LPM. For example, entering into and exiting from an LPM with the lowest level of power consumption (maximum energy savings) may have a higher entry/exit cost than an LPM with a higher level of power consumption (less energy savings). Therefore, it is important to select an optimal level of power consumption based on the duration of the period of inactivity.

### SUMMARY

Aspects disclosed herein include low-latency determination of optimal low-power modes (LPMs) of inactive circuits in an integrated circuit (IC). Related power management methods of determining optimal LPMs of an inactive circuit with low latency are also disclosed. Some logic circuits in an IC may have periods in which they are in an inactive (e.g., idle) state, such as when the functions they provide are not needed, and during which they continue to consume power. A power manager in an IC detects activity states of circuits and may cause a circuit to enter an LPM while the circuit is inactive (e.g., idle). In an exemplary IC, a power manager provides an indication of a duration of an inactive state of a circuit (e.g., a logic circuit) to a lookup table and receives an LPM identifier for the circuit based on the duration of the inactive state. The power manager also causes the circuit to enter the LPM identified by the LPM identifier. In some examples, the LPM identified by the lookup table circuit may be an optimal LPM among a plurality of LPMs for the circuit, based on the duration of the inactive state. In this context, an optimal LPM is one that provides the best energy savings among the available LPMs for the circuit for the duration of the inactive state. In some examples, the lookup table circuit is populated with LPM identifiers of the LPMs for the circuit and each LPM may provide be the optimal LPM for a corresponding range of duration of inactivity. In some examples, the power manager circuit may provide, in addition to the duration of inactivity, at least one of a circuit identifier, a circuit frequency, a memory interface frequency, and a temperature to the lookup table circuit to identify the optimal LPM.

In this regard, in one aspect, an IC is disclosed. The IC includes a first circuit, a first lookup table circuit, and a power manager. The power manager is configured to detect an inactive state in a first circuit in an IC, provide, to the first lookup table circuit, an indication of a first duration of the inactive state of the first circuit, receive, from the first lookup table circuit, a first LPM identifier of the first circuit based on the first duration of the inactive state of the first circuit and cause the first circuit to enter a first LPM identified by the first LPM identifier.

In another aspect, a method of reducing energy consumption in an IC is disclosed. The method includes detecting, in a power manager, an inactive state of a first circuit in an IC, providing, to a first lookup table circuit and an indication of a first duration of the inactive state of the first circuit. The method also includes receiving, from the first lookup table circuit, a first LPM identifier of the first circuit based on the first duration of the inactive state of the first circuit and causing, by the power manager, the first circuit to enter a first LPM identified by the first LPM identifier.

### BRIEF DESCRIPTION OF THE DRAWINGS

FIG. 1 is a block diagram of an exemplary integrated circuit (IC), including a power manager that, with minimal latency, determines a low-power mode (LPM) of a circuit based on an anticipated duration of circuit inactivity to optimize power savings;

FIG. 2A is a graph of the energy consumption of a circuit over a period of time, including entry into and exit from an LPM, wherein areas of the graph correspond to power consumption and power savings associated with the LPM;

FIG. 2B is a graph of the energy consumption of a circuit, as shown in FIG. 2A, in two LPMs having different rates of power consumption and entry/exit costs;

FIG. 3 is an illustration of a lookup table circuit, which may be any of the lookup table circuits in FIG. 1 and includes, in each column, a plurality of LPMs of a circuit corresponding to the column, where the LPMs are indexed by corresponding minimum or maximum durations;

FIG. 4 is a flowchart of an exemplary process for selecting an LPM to optimize power savings of a circuit in an IC depending on a duration of inactivity in the circuit;

FIG. 5 is a block diagram of an exemplary wireless communication device that includes radio-frequency (RF) components that can be disposed on ICs, including ICs including a power manager that, with minimal latency, determines an LPM of a circuit based on an anticipated duration of inactivity in the circuit to optimize power savings; and

FIG. 6 is a block diagram of an exemplary processor-based system that can include ICs, including a power manager that, with minimal latency, determines an LPM of a circuit based on a duration of inactivity in the circuit to optimize power savings.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” should not necessarily be construed as preferred or advantageous over other aspects.

Aspects disclosed herein include low-latency determination of optimal low-power modes (LPMs) of inactive circuits in an integrated circuit (IC). Related power management methods of determining optimal LPMs of an inactive circuit with low latency are also disclosed. Some logic circuits in an IC may have periods in which they are in an inactive (e.g., idle) state, such as when the functions they provide are not needed, and during which they continue to consume power. A power manager in an IC detects activity states of circuits and may cause a circuit to enter an LPM while the circuit is inactive (e.g., idle). In an exemplary IC, a power manager provides an indication of a duration of an inactive state of a circuit (e.g., a logic circuit) to a lookup table circuit and receives an LPM identifier for the circuit based on the duration of the inactive state. The power manager also causes the circuit to enter the LPM identified by the LPM identifier. In some examples, the LPM identified by the lookup table circuit may be an optimal LPM among a plurality of LPMs for the circuit, based on the duration of the inactive state. In this context, an optimal LPM is one that provides the best energy savings among the available LPMs for the circuit for the duration of the inactive state. In some examples, the lookup table circuit is populated with LPM identifiers of the LPMs for the circuit and each LPM may provide be the optimal LPM for a corresponding range of duration of inactivity. In some examples, the power manager circuit may provide, in addition to the duration of inactivity, at least one of a circuit identifier, a circuit frequency, a memory interface frequency, and a temperature to the lookup table circuit to identify the optimal LPM.

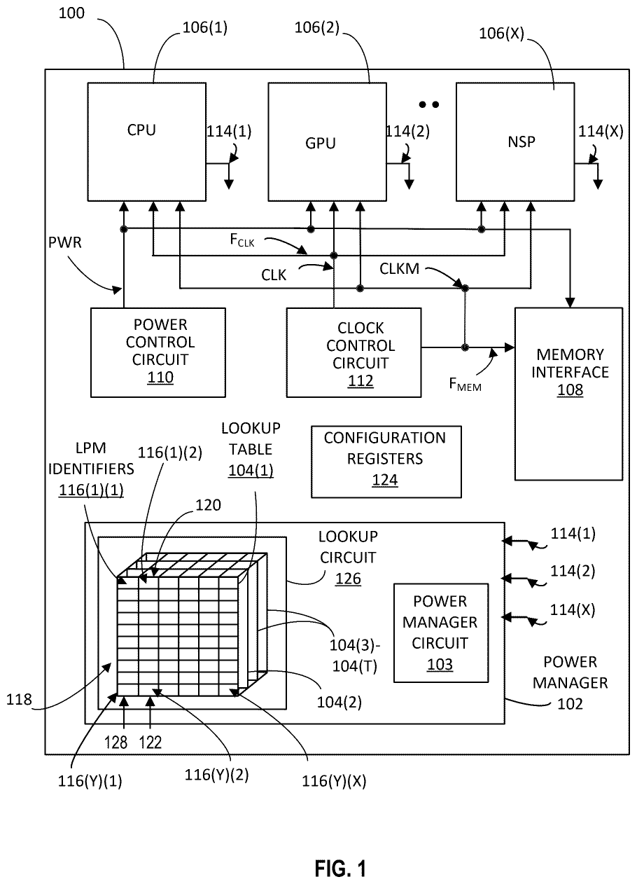

FIG. 1 is a block diagram of a first example of an IC 100, including a power manager 102 that employs a first lookup table 104(1) to store up to “Y” different LPM identifiers that identify up to Y LPMs (where Y is a positive integer) for each of circuits 106(1)-106(X). The lookup table 104(1) may be a lookup table circuit or a lookup table implemented in a memory circuit, for example. The lookup table 104(1) determines optimal LPMs for inactive states of the circuits 106(1)-106(X) based on durations of the respective inactive states. The power manager 102 in the IC 100 includes a power manager circuit 103, which may be implemented as hardware circuits, such as logic circuits and sequential circuits, or as a processor circuit configured to execute instructions stored in a non-volatile computer-readable medium (not shown). Thus, the power manager 102 may be controlled by hardware circuits configured to control a lookup table circuit or a memory circuit in which a lookup table is stored, or the power manager 102 may be implanted as a processor configured to execute instructions that control a lookup table circuit or a memory circuit in which a lookup table is stored.

Each of the circuits 106(1)-106(X) may be any combination of logic circuits, analog circuits, and storage circuits (not shown). In this example, the first circuit 106(1) may be a central processing unit (CPU), the second circuit 106(2) may be a graphics processing unit (GPU), and the third circuit 106(X) (may also be referred to as 106(3)) may be a network signal processor (NSP). Although the number X=3 herein, the number and types of circuits 106(1)-106(X) described herein are intended to be a non-limiting example provided for explanation only. In the following discussion, reference is made to the circuit 106(1), which is used as an example for explanation purposes but it should be understood that descriptions thereof may apply to any and all of the circuits 106(1)-106(X).

The IC 100 also includes a memory interface 108 through which the circuits 106(1)-106(X) may be coupled to a memory (not shown). The memory interface 108 may be used by the circuits 106(1)-106(X) to access instructions and/or data for processing. There may be other signals and/or interfaces in the IC 100 that couple to the circuits 106(1)-106(X), not shown in FIG. 1, and which may prompt or trigger the circuits 106(1)-106(X) to perform tasks, which may include fetching instructions and/or fetching and storing data through the memory interface 108.

During normal operation of the IC 100, there may be times at which one or more of the circuits 106(1)-106(X) are idle and not performing any task, and during such times the idle circuits 106(1)-106(X) are described as being in an inactive state. During an active (not idle) state, the circuits 106(1)-106(X) are functioning normally, which may include changing states and/or generating signals and/or data, for example. During an inactive state, a power control circuit 110 may continue to provide power to the circuit 106(1), and a clock control circuit 112 may continue to provide an active clock signal CLK. This condition is referred to herein as a full power mode because the circuit 106(1) will continue to consume power. When the clock signal CLK is active, the clock signal CLK continues to cycle between a higher voltage state and a lower voltage state, which can cause the charging and discharging of logic circuits and storage circuits in the circuit 106(1). Since this charging and discharging is due to the clock signal CLK, the rate of power consumption in the circuit 106(1) in the inactive state may be dependent on a first frequency F_{CLK} of the clock signal CLK. Such power consumption in the IC 100 by one or more of the circuits 106(1)-106(X) can contribute to heating of the IC 100 and/or reducing the life of batteries that provide power to the IC 100.

In addition, communication with the memory interface 108 may require at least some portion of the circuit 106(1) to operate at a second frequency F_{MEM} of the memory interface 108 based on a memory clock signal CLKM. For example, the memory interface 108 may be coupled to a double-data rate (DDR) memory (not shown) for which the memory clock signal CLKM is at a higher frequency than (e.g., twice) the first frequency F_{CLK} of the clock signal CLK. In this regard, the rate of power consumption in the circuit 106(1) in an inactive state may also depend on the second frequency F_{MEM} of the memory interface 108.

A function of the power manager 102 is to minimize the amount of power the circuits 106(1)-106(X) consume during their respective inactive states. In this regard, the power manager 102 may receive state signals 114(1)-114(X) indicating the states of the circuits 106(1)-106(X). The state signals 114(1)-114(X) allow the power manager 102 to detect whether the circuits 106(1)-106(X) are in active states or inactive states. In some examples, the state signals 114(1)-114(X) may not be received from the circuits 106(1)-106(X) directly and instead may be received from one or more other circuits (e.g., state manager) on the IC 100.

In response to detecting that the circuit 106(1) is in an inactive state, the power manager 102 can take actions to reduce the power consumption in the circuit 106(1). For example, the power manager 102 can control the clock control circuit 112 to turn off (e.g., stop cycling of) the clock signal CLK and/or the memory clock signal CLKM to the circuit 106(1). Alternatively or additionally, the power manager 102 can control the power control circuit 110 to turn off (e.g., stop providing) a power signal PWR supplied to the circuit 106(1). Turning off any combination of the clock signal CLK, the memory clock signal CLKM, and the power signal PWR may reduce power consumption in the circuit 106(1). Thus, while any of the clock signal CLK, the memory clock signal CLKM, and/or the power signal PWR are turned off in the circuit 106(1), the circuit 106(1) may be described as being in an LPM in which power consumption of the circuit 106(1) decreases.

Turning off the clock and power signals to the entire circuit 106(1), for example, is one way for the power manager 102 to cause the circuits 106(1)-106(X) to enter an LPM. Depending on the circuit 106(1) and its function, there may be alternative and/or additional options for controlling the power consumption of the circuit 106(1). In some examples, certain functions may be stopped or limited while the clocks and power are still active. In alternative examples, clock and power signals may be turned off to one or more portions of a circuit rather than an entire circuit. For example, the circuit 106(1) may include storage circuits configured to store essential data. During some LPMs, power to the storage circuits may be maintained to prevent loss of the essential data. Alternatively, in some LPMs, power may be turned off to the storage circuit and, to prevent loss of essential data stored in the storage circuit, the data may be copied or backed up to another storage circuit internal or external to the IC 100, where it can be preserved while the power signal PWR is turned off to the storage circuits in the circuit 106(1).

Backing up data is just one example of preparatory actions that may be needed before the circuit 106(1) can enter into an LPM. The numbers and types of preparatory actions that may be required for the circuits 106(1)-106(X) to enter into LPMs vary based on the circuits 106(1)-106(X) and on the LPM to be entered. The preparatory actions may depend on the rate of continued power consumption that will occur while the circuit 106(1) is resident in an LPM. In the above example, in a first LPM, in which the power signal PWR to the storage circuits is turned off, the circuit 106(1) may have a lower rate of power consumption while resident in the inactive state than while resident in a second LPM in which the power signal PWR remains active. However, backing up data to prepare to enter into the first LPM would consume energy and consume some of the duration of the inactive state. In this regard, although the first LPM may have a lower rate of power consumption, the energy and time consumed to enter the first LPM (referred to herein as entry cost) is not incurred when entering the second LPM.

Similarly, when exiting an LPM and returning back to the active mode from an LPM, more power and time (referred to herein as exit cost) may be consumed by the restorative actions (e.g., restoring the backed-up data) of those LPMs having lower rates of power consumption than the power consumed to exit from LPMs with higher rates of power consumption. Each LPM of the plurality of LPMs for a circuit 106(1) may have a unique rate of power consumption among the rates of power consumption of the plurality of LPMs. In some examples, two or more LPMs for a circuit 106(1) may have a same rate of power consumption but may have different entry/exit costs. Entering into and exiting from an LPM may consume more energy than simply remaining in a full power mode in the inactive state, but the power savings achieved in the LPM can more than make up for the entry/exit costs if the circuit 106(1) is resident in the LPM for a sufficiently long duration.

One objective of the power manager 102 is to minimize the total energy consumption during the inactive state of the circuits 106(1)-106(X), by causing the circuits 106(1)-106(X) to enter into LPMs that will have the least total energy consumption (e.g., conserve the most power) among the LPMs available for a circuit during the inactive state. That is, the power manager 102 may control the circuits 106(1)-106(X) to enter optimal LPMs. In this regard, the time and energy consumed for entry into and exiting from (entry/exit costs for) each of the LPMs is considered together with the duration for which the circuits 106(1)-106(X) will be resident in the LPM. In this context the term “resident in the LPM” refers to a period after preparatory actions for entering the LPM are complete and before restorative actions for exiting the LPM are initiated. To achieve a minimum power/energy consumption, the power manager 102 may determine the optimal LPM for an inactive state based on a duration of the inactive state.

When the power manager 102 detects that the circuit 106(1) is in an inactive state, the power manager 102 generates an indication of a first duration 128 of the inactive state of the circuit 106(1). The indication of the first duration 128 may be generated based on an expected or known minimum duration of inactivity from the state signals 114(1)-114(X) or from other information. In some examples, the indication of the first duration 128 may be generated based on information provided to the power manager 102 by the circuits 106(1)-106(X) or by other circuits in the IC 100. The duration of an inactive state may be determined in any appropriate manner.

The lookup table 104(1) may store up to Y LPM identifiers for each of the circuits 106(1)-106(X). Thus, in this example, the lookup table 104(1) stores LPM identifiers 116(1)(1)-116(Y)(X), where Y is a maximum number of LPMs for any of the circuits 106(1)-106(X).

The power manager 102 accesses the lookup table 104(1) to obtain a first LPM identifier 118 for the circuit 106(1) based on the indication of the first duration 128 of the inactive state of the circuit 106(1). The first LPM identifier 118 may be any of the LPM identifiers 116(1)(1)-116(Y)(1). The indication of the first duration 128 may indicate a number of cycles or a period of time, for example, of inactivity in the circuit 106(1). The power manager 102 may cause the circuit 106(1) to enter a first LPM identified by the first LPM identifier 118. For example, the power manager 102 may generate one or more signals directly to the circuit 106(1), to the clock control circuit 112, to the power control circuit 110, and/or to other circuits in the IC 100 to cause the circuit 106(1) to enter the first LPM indicated by the first LPM identifier 118 received from the lookup table 104(1). Other circuits, such as the memory interface 108, in the IC 100 may also be involved in the preparatory actions and restorative actions discussed above.

As noted above, the rate of power consumption during an inactive state may depend on the frequency F_{CLK} of the clock signal CLK or the frequency F_{MEM} of the memory clock CLKM provided to the memory interface 108. The first circuit, 106(1), may be configured to operate at a plurality of different frequencies FCLK of the clock signal CLK, and the memory interface 108 may be configured to operate at a plurality of different frequencies F_{MEM} of the memory clock CLKM. Thus, in some examples, the power manager 102 may access the lookup table 104(1) to obtain the first LPM identifier 118 based on an indication of the frequency F_{CLK} of the clock signal CLK in the circuit 106(1). In some examples, the power manager 102 may access the lookup table 104(1) to obtain the first LPM identifier 118 based on an indication of the frequency F_{MEM} of the memory interface 108 to the lookup table 104(1) and receive the first LPM identifier 118 based on the frequency F_{MEM} of the memory interface 108. In some examples, the power manager 102 may provide both of the frequency F_{CLK} and the frequency F_{MEM} to the lookup table 104(1) and receive an indication of the LPM in return. Factors such as the frequency F_{CLK}, the frequency F_{MEM}, IC temperature information, as well as other types of information may be employed by the power manager 102, may be stored in configuration registers 124, where it can be accessed by the power manager 102. Any of such factors may affect the dimensions of the lookup table circuits.

In some cases, an identifier of the circuit 106(1) may additionally or alternatively be provided to the lookup table 104(1) by the power manager 102. Since the function (GPU) of the second circuit 106(2) differs from the function (CPU) of the first circuit 106(1) in the example in FIG. 1, the LPMs available for the second circuit 106(2) may differ from those available for the first circuit 106(1). Thus, when the power manager 102 detects an inactive state in the second circuit 106(2) in the IC 100, the power manager 102 may generate an indication of a second duration of the inactive state of the second circuit 106(2), and may access a second lookup table 104(2), which may be a second lookup table circuit to obtain a second LPM identifier 120 based on the second duration of the inactive state of the second circuit 106(2). The power manager 102 may then cause the second circuit 106(2) to enter the second LPM identifier 120. As shown in FIG. 1, the lookup table 104(1) and the second lookup table 104(2) may both be included in a lookup circuit 126. In some examples, the lookup table 104(1) and the second lookup table 104(2) may be in separate lookup circuits. The lookup circuit 126 may include any number of additional lookup table circuits (“lookup tables”) 104(3)-104(T) depending on factors relied on to determine the optimal LPMs. In some examples, the lookup tables 104(1)-104(T) may include more than two dimensions, to organize the indications of LPMs by three or more indexes being considered to determine an optimal LPM.

In the present example, the first lookup table 104(1) contains LPM identifiers 116(1)(1)-116(Y)(X) for multiple circuits 106(1)-106(X). In such example, the power manager 102 may access the first lookup table 104(1) to obtain the first LPM identifier 118 based on an identifier of the first circuit 106(1). In this example, the power manager 102 may detect an inactive state in the second circuit 106(2) in the IC 100 and access the first lookup table 104(1) to obtain an indication of the second duration 122 of the inactive state of the second circuit 106(2) based on an identifier of the second circuit 106(2). The power manager 102 may receive, from the first lookup table 104(1), a second LPM identifier 120 for the second circuit 106(2) based on the identifier of the second circuit 106(2) and the second duration 122. The power manager 102 may cause the second circuit 106(2) to enter a second LPM identified by the second LPM identifier 120. The second LPM identifier 120 may be any of the LPM identifiers 116(1)(2)-116(Y)(2).

In some examples, there may be multiple power managers 102, each configured to control one or more of the circuits 106(1)-106(X). Each of such power managers may include corresponding lookup table(s) 104(1) and operate as described herein.

In some examples, the duration of the inactive state of the circuit 106(1) may be too short to compensate for (e.g., provide a power savings to offset) the entry/exit costs of some LPMs. The first lookup table 104(1) may be configured to indicate an LPM for the circuit 106(1) only if the duration of the inactive state of the circuit 106(1) provides a net power savings. In particular, the first lookup table 104(1) may be configured to identify an optimal LPM based on the duration of the inactive state. In this regard, the first lookup table 104(1) may be indexed according to minimum or maximum durations, as discussed below.

For a given circuit 106(1), there may be more than one LPM that could reduce power consumption (compared to full power mode) during an inactive state and each of such LPMs may have a unique rate of power consumption different than that of the other LPMs, as described above. That is, if the lookup table 104(1) includes, for example, five LPMs available for the circuit 106(1), a first LPM and a second LPM (e.g., as identified by LPM identifiers 116(1)(1) and 116(2)(1)) may not provide a net energy savings for an inactive state of a first duration 128 that is too short, but a third, fourth, and fifth LPMs may be determined to provide a net reduction in energy consumption in the first circuit 106(1) compared to the full power mode for the first duration 128 of an inactive state. The third, fourth, and fifth LPMs in this example may generally reduce energy consumption by different amounts, and the lookup table 104(1) may be configured to return the optimal LPM, which is the LPM among the third, fourth, and fifth LPMs available for the circuit 106(1), providing the greatest net energy savings for the circuit 106(1) in an inactive state of duration 128.

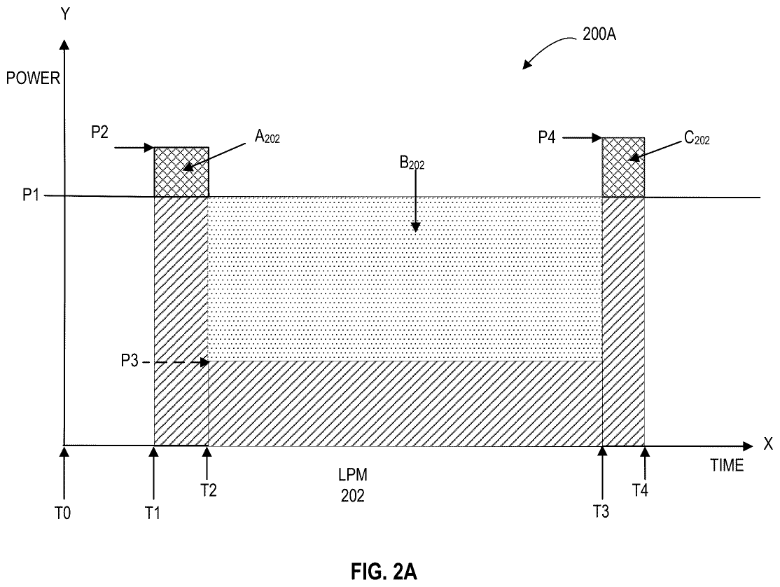

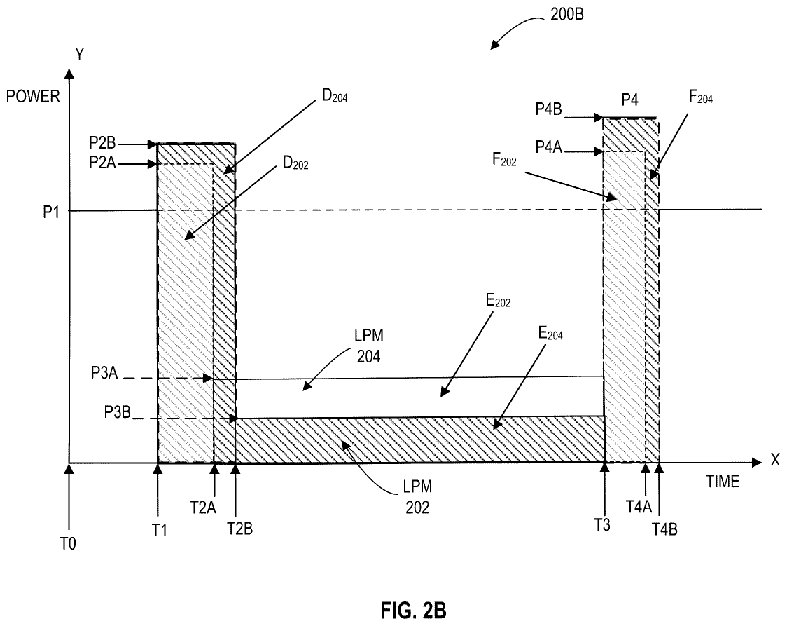

FIG. 2A is a graphical representation (graph) 200A that illustrates the power consumption of an example circuit, such as one of the circuits 106(1)-106(X), during a period that includes entry into and exit from an LPM. FIG. 2 shows the power consumption at a rate P1 of the circuit in an inactive state between time T0 and T1, referred to herein as a “full power mode”, before entry into an LPM 202. In the graph 200A, rates of power consumption (power) of the circuit increase along the Y-axis and time increases along the X-axis in the graph 200. Here, the circuit consumes power at the rate P1 while performing no tasks or functions before the power manager 102 in FIG. 1 causes the circuit to enter the LPM 202.

At time T1, the power manager 102 causes preparatory actions to be initiated in the circuit to prepare for entering into the LPM 202. As described above, preparatory actions may include backing up essential data, for example, but may include other actions needed to ensure that the circuit returns to normal operation after being resident in the LPM 202 during the inactive state. These preparatory actions cause power consumption to increase in the circuit as it transitions from a fully powered, inactive state to a state in which it performs preparatory actions. The graph 200 displays the increased rate of power consumption P2 for the time T1 to T2 as an area A₂₀₂, which represents a total energy consumed beyond the power that would have been consumed by staying in the full power mode during the same period (i.e., from T1 to T2). The area A₂₀₂ is referred to herein as an “entry cost” for entering the LPM 202. The area A₂₀₂ is preferably minimized to avoid excessive energy consumption. The choice of LPM to be employed for a given inactive state may be based in part on the area A₂₀₂. The preparatory actions may be initiated by the power manager 102 in response to receiving an indication of the LPM 202 from the first lookup table 104(1) in FIG. 1.

When the preparatory actions are complete at time T2, the rate of power consumption drops to P3. P3 is the rate of power consumption occurring while the circuit is resident in the LPM 202, from time T2 to time T3. Here, the rate of power consumption P3 may be considerably lower than the rate P1 in the full power mode. An area B₂₀₂ illustrates the power savings or benefit attained by causing the circuit to enter into the LPM 202 rather than remaining inactive in the full power mode at the power consumption rate P1. The area B₂₀₂ extends in the Y-axis direction between P1 and P3 and in the X-axis direction from T2 to T3. The area B₂₀₂ is preferably maximized to maximize energy savings.

At time T3, the circuit begins restorative actions to exit the LPM 202. During these restorative actions, from time T3 to time T4, the circuit has a rate of power consumption P4, which is higher than the rate P1 of the full power mode. Upon completion of the restorative actions (at time T4), the circuit is back to the full power mode having a rate of power consumption P1 again. The excess energy consumed by the restorative actions at the rate P4, above the full power mode P1, is shown as area C₂₀₂ and is referred to herein as an exit cost to exit the LPM 202. Minimizing the area C₂₀₂ can reduce the total energy consumption of the LPM 202.

FIG. 2A is provided to illustrate that there is both a cost to enter (A₂₀₂) and a cost to exit (C₂₀₂) the LPM 202 and that, for the LPM 202 to provide a net power savings to the circuit, the savings (B₂₀₂) attained while resident in the LPM 202 must exceed a total of the cost to enter (A₂₀₂) and the cost to exit (C₂₀₂). In equation form, this is stated as: B₂₀₂>(A₂₀₂+C₂₀₂). The LPM 202 is clearly beneficial in this example because the area B₂₀₂ is much larger than a total of A₂₀₂ and C₂₀₂. However, in some examples, B₂₀₂<(A₂₀₂+C₂₀₂) for the available LPMs based on the duration of the inactive state. In such situations, energy consumption may be minimized by staying in the full power mode.

Even though some LPMs may have an extremely low rate of power consumption, the costs to enter and exit them may be greater than the corresponding savings if the duration 128 of the inactive state of a circuit is too short. Thus, when a duration 128 is provided to the lookup table 104(1) in FIG. 1, some LPMs may be eliminated from consideration because they would not provide a net power savings for the circuit.

FIG. 2B is a graph 200B corresponding in some aspects to the graph 200A, showing the rates of power consumption of a circuit entering into, resident in, and exiting from the LPM 202. Graph 200B also shows the rates of power consumption of the circuit entering into, resident in, and exiting from another LPM 204 for purposes of comparison. FIG. 2B is provided to illustrate how to determine a duration threshold, which is a duration at which two LPMs with different rates of power consumption and entry/exit costs have a same net energy savings. The duration threshold may also be referred to as a break-even point at which the circuit would achieve the same power savings in either of the two LPMs. For an inactive state having a duration N greater than the duration threshold, one of the LPMs provides greater net power savings, and for an inactive state having a duration N less than the duration threshold, the other one of the LPMs provides a greater net power savings.

The power manager 102 in FIG. 1 may be configured to cause the circuit to enter one of the two LPMs 202 and 204 based on a comparison of the first duration 128 of inactivity to a duration threshold. The duration threshold between the LPMs 202 and 204, for example, may be indicated as a maximum duration corresponding to the LPM 204 or as a minimum duration corresponding to the LPM 202. In other words, when the indicated first duration 128 of the inactive state is shorter than the duration threshold between the LPMs 202 and 204, power manager 102 in FIG. 1 may cause the first circuit 106(1) to enter the LPM 204, and when the indicated first duration 128 is longer than the duration threshold, the power manager 102 may cause the first circuit 106(1) to enter the LPM 202. It should be understood that, in this example, the two LPMs 202, 204 are among the LPMs that would provide a net power savings at the indicated duration N of the inactive state, as explained with respect to FIG. 2A. In some examples, when duration thresholds are provided as minimum thresholds of the LPMs, it may be determined that the duration of inactivity is lower than the minimum threshold of any LPM. In such examples, the first circuit 106(1) may not enter any LPM.

Since details of the LPM 202 were explained above with reference to graph 200A, they are not fully restated with reference to graph 200B. The rates of power consumption P2, P3, and P4 for the LPM 202 shown in graph 200A are designated in graph 200B as P2A, P3A, and P4A, respectively. Graph 200B also shows rates of power consumption of the circuit during preparatory actions to enter LPM 204, residence in the LPM 204, and restorative actions to exit from the LPM 204, respectively, as rates P2B, P3B, and P4B for purposes of comparing LPM 202 to LPM 204.

Here, rather than measuring power consumption relative to the full power mode, the total energy consumption associated with LPM 204 is compared to the total energy consumption at each stage associated with LPM 202. The area D₂₀₂ shows the total energy consumed at the rate P2A during the preparatory actions for entering the LPM 202 from time T1 to time T2A. The area E₂₀₂ represents the total energy consumed at the rate P3A while resident in the LPM 202 from time T2A to time T3, and the area F₂₀₂ represents the energy consumed at the rate P4A during the restorative actions to return from the LPM 202 to full-power mode from time T3 to time T4A.

In contrast, the area D₂₀₄ represents the total energy consumed at the rate P2B during the preparatory actions for entering the LPM 204 from time T1 to time T2B. The area E₂₀₄ represents the total energy consumed at the rate P3B from time T2B to time T3, and the area F₂₀₄ represents the total energy consumed at the rate P4B during the restorative actions from time T3 to time T4B. As shown in graph 200B, the preparatory actions and restorative actions of the LPM 204 consume power at a higher rate (P2B and P4B creating higher entry/exit costs) than the corresponding actions for entering and exiting the LPM 202 (P2A and P4A). In addition, entry into and exiting from the LPM 204 takes longer than the corresponding entry into and exiting from the LPM 202. These differences cause a higher total power consumption to enter into and exit from the LPM 204 than for the LPM 202. This difference is shown as the difference between the areas D₂₀₂ and D₂₀₄ and the difference between the areas F₂₀₂ and F₂₀₄. As a result, the entry/exit costs of the LPM 202 are lower than those of the LPM 204.

However, because the rate of power consumption P3B of the LPM 204 is lower than the rate P3A of the LPM 202, the circuit would consume less total power in the LPM 204 than in the LPM 202 if the duration of the inactive state is long enough. A “break-even point”, referred to herein as the duration threshold, is a duration of an inactive state for which entry into, residency in, and exiting from a first LPM would consume a same total amount of energy in a circuit as entry into, residency in, and exiting from a second LPM. In other words, at a duration threshold between the first LPM and the second LPM, the reduction in power consumption for a circuit would be the same in the first LPM as in the second LPM. Thus, the duration threshold may be identified as a maximum duration for a range of durations corresponding to the first LPM or as a minimum duration for a range of durations corresponding to the second LPM. For a shorter duration, the first LPM may provide the greater net power savings, and for a longer duration, the second LPM may provide the greater net power savings.

Graphically, the duration threshold would be when a total energy consumed by the LPM 202 and the LPM 204 are the same, which would be true when, as illustrated in graph 200B, the total of areas D₂₀₂, E₂₀₂, and F₂₀₂ are equal to the total of areas D₂₀₄, E₂₀₄, and F₂₀₄. Stated as an equation, the duration threshold would be achieved when:

$${D}_{202} + {E}_{202} + {F}_{202} = {D}_{204} + {E}_{204} + {F}_{204} , in figure 2 B .$$

The above equation can be used to determine, for each LPM identified in the lookup table for the first circuit and a next LPM identified in the lookup table for the first circuit, a duration threshold at which net power savings of the LPM and net power savings of the next LPM is equal. A “next LPM” in this context may be an LPM having a next higher or lower rate of power consumption among the LPMs for the first circuit in the lookup table.

Other equations may be used to identify the duration threshold at which two LPMs have a break-even point. For example, the costs of entry into an LPM and exit from an LPM may be considered as only the power consumption in excess of the full power mode, and the power savings may also be considered as a savings relative to the full power mode. Thus, a threshold duration between two LPMs would be at a duration at which reductions of power consumption in the two LPMs identified by the plurality of LPM identifiers are equal, where the reduction of power consumption is based on a total of the entry costs, exit costs, and power savings for the two LPMs.

One example of an alternative equation is the following:

$${t}_{L P M {n}_{{E}_{threshld}}} = \frac{( \begin{matrix}{t}_{2 n} + {t}_{4 n} {dP}_{3 n} - ( {t}_{2 n - 1} + {t}_{4 n - 1} ) d {P}_{3 n - 1} + {t}_{2 n} d {P}_{2 n} + \\ {t}_{4 n} d {P}_{4 n} - ( {t}_{2 n - 1} d {P}_{2 n - 1} + {t}_{4 n - 1} d {P}_{4 n - 1}\end{matrix} )}{d {P}_{3 n} - d {P}_{3 n - 1}}$$

n=2, 3 . . . until the LPM having the lowest power consumption is reached.

In the above example, “n−1” and “n” refer to LPMs having different rates of power consumption (for example, LPM “n−1” may provide a next higher level of power consumption than LPM “n” but have higher entry/exit cost);
t₂ₙ=time from T1 to T2 in FIG. 2B for the LPM “n”;
t₄ₙ=time from T3 to T4 for LPM “n”;
dP₂ₙ=difference between P1 and P2 for LPM “n”;
dP₃ₙ=difference between P1 and P3 for LPM “n”;
dP₄ₙ=difference between P1 and P4 for LPM “n”; and

$${t}_{{LPMn}_{{E}_{threshld}}} = the time of an inactive state at which there \\ \\ \\ is a break - even point between LPM “ n ” and LMP “ n - 1 ” .$$

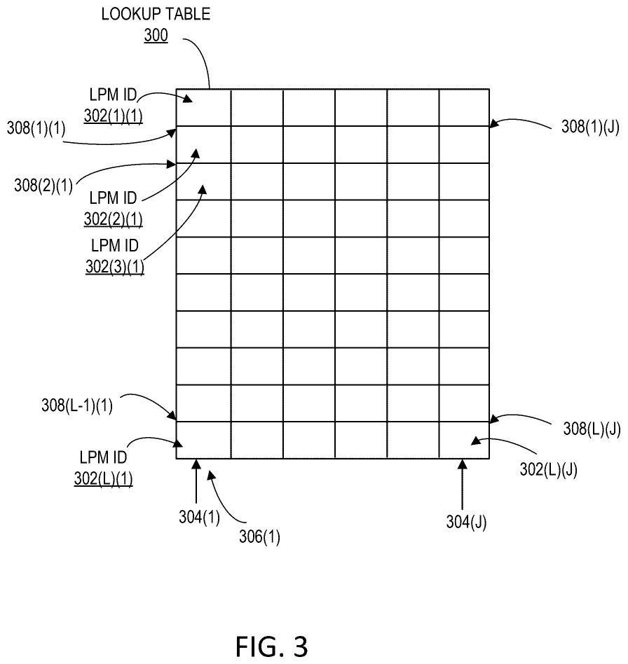

As illustrated in FIG. 3, a lookup table 300, which may be any of the lookup tables 104(1), 104(2), and 104(3)-104(T) in the lookup circuit 126 in FIG. 1, may store a plurality of (e.g., up to L=10 or more) LPM identifiers (LPM IDs) 302(1)(1)-302(L)(J) including the first LPM identifier 118, where the LPM IDs 302(1)(1) through 302(L)(1) in column 304(1) identify LPMs for a circuit 306(1) and each of the columns 304(1)-304(J) corresponds to one of a plurality of circuits 306(1)-306(J). The circuits 306(1)-306(J) may be the circuits 106(1)-106(X) in FIG. 1. In some examples, the respective rates of power consumption for the circuit 306(1) resident in the LPMs identified by the LPM IDs 302(1)(1)-302(L)(1) progressively decrease (e.g., the rates of power savings increase) with the index (e.g., 1 to L). For example, the rate of power consumption for the circuit 306(1) while resident in the LPM identified by the LPM ID 302(1)(1) may be higher than the rate of power consumption in the circuit 306(1) while resident in the LPM identified by the LPM ID 302(2)(1), the rate of power consumption for the circuit 306(1) resident in LPM identified by the LPM ID 302(2)(1) is higher than the rate in the LPM identified by the LPM ID 302(3)(1), and so on. Conversely, although the LPM identified by the LPM ID 302(1)(L) has the lowest rate of power consumption for the circuit 306(1), the LPM identified by the LPM ID 302(1)(L) may have the greatest entry/exit costs. Thus, the LPM identified by the LPM ID 302(1)(1) may be most beneficial in shorter duration periods of inactivity and the LPM identified by the LPM ID 302(1)(L) may be the most beneficial in the longest duration periods of inactivity.

Duration thresholds 308(1)(1)-308(L)(J) may be minimum or maximum durations used to identify ranges of durations of inactivity for which the respective LPM IDs 302(1)(1)-302(L)(J) would be optimal. The duration thresholds 308(1)(1)-308(L−1)(J) may indicate break-even points, calculated as discussed above, between the respective LPMs identified by the LPM IDs 302(1)(1)-302(L)(1). The indication of duration of inactivity generated in the power manager 102 in FIG. 1 may be compared to the duration thresholds 308(1)(1)-308(L)(J) to determine which of the LPM IDs 302(1)(1)-302(L)(J) would indicate the optimal LPM. In some examples, the duration threshold 308(1)(1) may indicate a minimum duration in a range of durations for which the LPM identified by the LPM ID 302(1)(1) would provide a net energy savings. Thus, as an example, for a duration of inactivity less than the duration threshold 308(1)(1), it may be more energy efficient to remain in the full power mode than to cause the first circuit 106(1) to enter the LPM indicated by the LPM ID 302(1)(1).

Alternatively, for a duration of inactivity greater than the duration threshold 308(1)(1) in such example, the duration may also be compared to the duration threshold 308(2)(1) and, if the duration is less than the duration 308(2)(1), the LPM ID 302(1)(1) may be provided to the power manager 102. In this example, if the duration is greater than the duration threshold 308(2)(1), the duration may be compared to the duration threshold 308(3)(1), and so on. In this regard, the duration thresholds 308(1)(1)-308(L)(J) identify ranges of durations of inactivity corresponding to the LPM IDs 302(1)(1)-302(L)(J) and the lookup table 300 may index the LPM IDs 302(1)(1)-302(L)(J) according to the corresponding ranges of durations. In some examples, the duration threshold 308(1)(1) may indicate a maximum duration for which the LPM identified by the LPM ID 302(1)(1) would provide a net energy savings, above which another LPM may provide a greater net energy savings.

Thus, for example, the duration of inactivity of the circuit 306(1) may be compared to the duration thresholds 308(1)(1)-308(L)(1) to identify which of the LPM IDs 302(1)(1)-302(L)(1) has a corresponding range of durations within which the duration of activity of the circuits 306(1)-306(J) is included. In this regard, the lookup table 300 may be employed to determine, with low latency, an optimal LPM for a given duration N of the inactive state of any one of the circuits 306(1)-306(J). That is, the duration threshold 308(1)(1) between the LPM identified by the LPM ID 302(1)(1) and the LPM identified by the LPM ID 302(2)(1) can be determined as described above. Similarly, each of the duration thresholds 308(2)(1)-308(L−1)(1) may be determined as described in reference to FIG. 2B.

The lookup table 300 stores the LPM IDs 302(1)(1)-302(L)(1) and indexes the LPM IDs according to the duration thresholds 308(1)(1)-308(L−1)(1), and identifies an optimal LPM among the LPMs identified by the LPM IDs 302(1)(1)-302(1)(L) to minimize power consumption in the first circuit for a duration N of inactivity in the circuit 306(1).

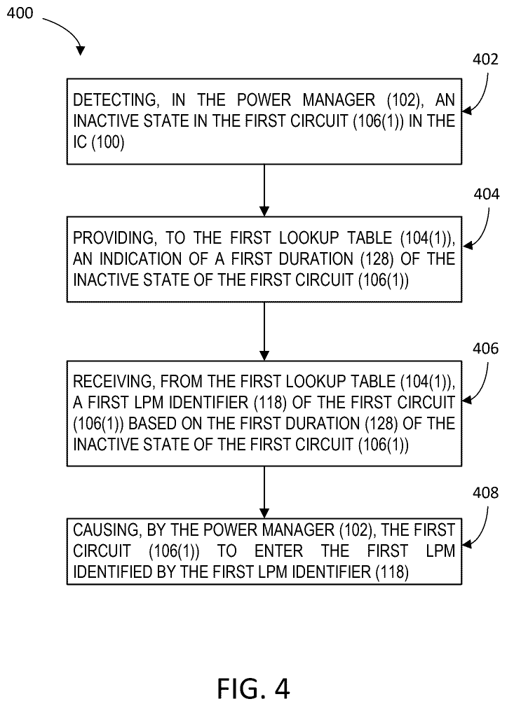

FIG. 4 is a flowchart of a method 400 of reducing power consumption in an IC, such as the IC 100 in FIG. 1, employing the lookup table 300 in FIG. 3. The method 400 includes detecting, in the power manager 102, an inactive state in the first circuit 106(1) in the IC 100 (block 402) and providing, to the first lookup table 104(1), an indication of a first duration 128 of the inactive state of the first circuit 106(1) (block 404). The method 400 includes receiving from the first lookup table 104(1), a first LPM identifier 118 of the first circuit 106(1) based on the first duration 128 of the inactive state of the first circuit 106(1) (block 406) and causing, by the power manager 102, the first circuit 106(1) to enter the first LPM identified by the first LPM identifier 118 (block 408). The power manager 102 causing the first circuit 106(1) to enter the first identified by the first LPM identifier 118 may include sending signal(s) directly to the first circuit 106(1) or sending signal(s) to another circuit, such as the clock control circuit 112 and/or the power control circuit 110.

ICs, including a power manager that, with minimal latency, determines a low-power mode of a circuit based on a duration of circuit inactivity to optimize power savings, as illustrated in FIG. 1, may be employed in any processor-based device. Examples of such processor-based devices, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, laptop computer, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, and a vehicle component.

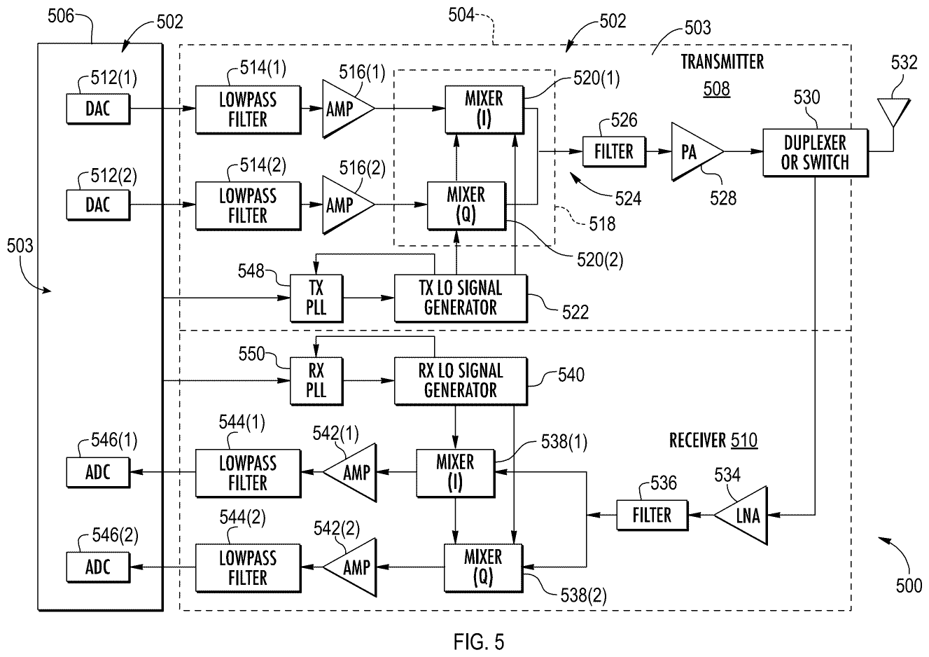

FIG. 5 illustrates an exemplary wireless communications device 500 that includes radio-frequency (RF) components formed from one or more ICs 502, wherein any of the ICs 502 may include a power manager that, with minimal latency, determines a low-power mode of a circuit based on an anticipated duration of circuit inactivity to optimize power savings, as illustrated in FIG. 1. The wireless communications device 500 may include or be provided in any of the above-referenced devices as examples. As shown in FIG. 5, the wireless communications device 500 includes a transceiver 504 and a data processor 506. The data processor 506 may include a memory to store data and program codes. The transceiver 504 includes a transmitter 508 and a receiver 510 that support bi-directional communications. In general, the wireless communications device 500 may include any number of transmitters 508 and/or receivers 510 for any number of communication systems and frequency bands. All or a portion of the transceiver 504 may be implemented on one or more analog ICs, RF ICs (RFICs), mixed-signal ICs, etc.

The transmitter 508 or the receiver 510 may be implemented with a super-heterodyne architecture or a direct-conversion architecture. In the super-heterodyne architecture, a signal is frequency-converted between RF and baseband in multiple stages, for example, from RF to an intermediate frequency (IF) in one stage and then from IF to baseband in another stage for the receiver 510. In the direct-conversion architecture, a signal is frequency-converted between RF and baseband in one stage. The super-heterodyne and direct-conversion architectures may use different circuit blocks and/or have different requirements. In the wireless communications device 500 in FIG. 5, the transmitter 508 and the receiver 510 are implemented with the direct-conversion architecture.

In the transmit path, the data processor 506 processes data to be transmitted and provides I and Q analog output signals to the transmitter 508. In the exemplary wireless communications device 500, the data processor 506 includes digital-to-analog converters (DACs) 512(1), 512(2) for converting digital signals generated by the data processor 506 into the I and Q analog output signals (e.g., I and Q output currents) for further processing.

Within the transmitter 508, lowpass filters 514(1), 514(2) filter the I and Q analog output signals, respectively, to remove undesired signals caused by the prior digital-to-analog conversion. Amplifiers (AMPs) 516(1), 516(2) amplify the signals from the lowpass filters 514(1), 514(2), respectively, and provide I and Q baseband signals. An upconverter 518 upconverts the I and Q baseband signals with I and Q transmit (TX) local oscillator (LO) signals through mixers 520(1), 520(2) from a TX LO signal generator 522 to provide an upconverted signal 524. A filter 526 filters the upconverted signal 524 to remove undesired signals caused by the frequency up-conversion as well as noise in a receive frequency band. A power amplifier (PA) 528 amplifies the upconverted signal 524 from the filter 526 to obtain the desired output power level and provides a transmit RF signal. The transmit RF signal is routed through a duplexer or switch 530 and transmitted via an antenna 532.

In the receive path, the antenna 532 receives signals transmitted by base stations and provides a received RF signal, which is routed through the duplexer or switch 530 and provided to a low noise amplifier (LNA) 534. The duplexer or switch 530 is designed to operate with a specific receive (RX)-to-TX duplexer frequency separation, such that RX signals are isolated from TX signals. The received RF signal is amplified by the LNA 534 and filtered by a filter 536 to obtain a desired RF input signal. Down-conversion mixers 538(1), 538(2) mix the output of the filter 536 with I and Q RX LO signals (i.e., LO_I and LO_Q) from an RX LO signal generator 540 to generate I and Q baseband signals. The I and Q baseband signals are amplified by AMPs 542(1), 542(2) and further filtered by lowpass filters 544(1), 544(2) to obtain I and Q analog input signals, which are provided to the data processor 506. In this example, the data processor 506 includes analog-to-digital converters (ADCs) 546(1), 546(2) for converting the analog input signals into digital signals to be further processed by the data processor 506.

In the wireless communications device 500 of FIG. 5, the TX LO signal generator 522 generates the I and Q TX LO signals used for frequency up-conversion, while the RX LO signal generator 540 generates the I and Q RX LO signals used for frequency down-conversion. Each LO signal is a periodic signal with a particular fundamental frequency. A TX phase-locked loop (PLL) circuit 548 receives timing information from the data processor 506 and generates a control signal used to adjust the frequency and/or phase of the TX LO signals from the TX LO signal generator 522. Similarly, an RX PLL circuit 550 receives timing information from the data processor 506 and generates a control signal used to adjust the frequency and/or phase of the RX LO signals from the RX LO signal generator 540.

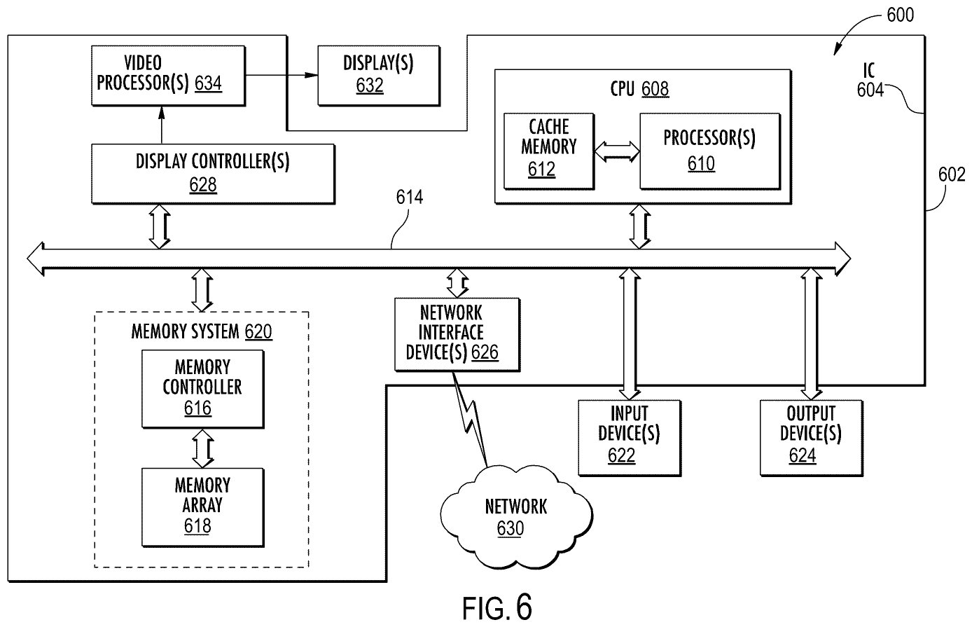

In this regard, FIG. 6 illustrates an example of a processor-based system 600 that can include ICs with a power manager that, with minimal latency, determines a low-power mode of a circuit based on a duration of circuit inactivity to optimize power savings, as illustrated in FIG. 1. The processor-based system 600 includes a central processing unit (CPU) 608 that includes one or more processors 610, which may also be referred to as CPU cores or processor cores. The CPU 608 may have cache memory 612 coupled to the CPU 608 for rapid access to temporarily stored data. The CPU 608 is coupled to a system bus 614 and can intercouple master and slave devices included in the processor-based system 600. As is well known, the CPU 608 communicates with these other devices by exchanging address, control, and data information over the system bus 614. For example, the CPU 608 can communicate bus transaction requests to a memory controller 616, as an example of a slave device. Although not illustrated in FIG. 6, multiple system buses 614 could be provided, wherein each system bus 614 constitutes a different fabric.

Other master and slave devices can be connected to the system bus 614. As illustrated in FIG. 6, these devices can include a memory system 620 that includes the memory controller 616 and a memory array(s) 618, one or more input devices 622, one or more output devices 624, one or more network interface devices 626, and one or more display controllers 628, as examples. The input device(s) 622 can include any type of input device, including, but not limited to, input keys, switches, voice processors, etc. The output device(s) 624 can include any type of output device, including, but not limited to, audio, video, other visual indicators, etc. The network interface device(s) 626 can be any device configured to allow an exchange of data to and from a network 630. The network 630 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 626 can be configured to support any type of communications protocol desired.

The CPU 608 may also be configured to access the display controller(s) 628 over the system bus 614 to control information sent to one or more displays 632. The display controller(s) 628 sends information to the display(s) 632 to be displayed via one or more video processor(s) 634, which processes the information to be displayed into a format suitable for the display(s) 632. The display(s) 632 can include any type of display, including, but not limited to, a cathode ray tube (CRT), a liquid crystal display (LCD), a plasma display, a light emitting diode (LED) display, etc.

Those of skill in the art will further appreciate that the various illustrative logical blocks, modules, circuits, and algorithms described in connection with the aspects disclosed herein may be implemented as electronic hardware, instructions stored in memory or in another computer-readable medium wherein any such instructions are executed by a processor or other processing device, or combinations of both. The devices and components described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from and write information to the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

Implementation examples are described in the following numbered clauses:

1. An integrated circuit (IC) comprising:
a first circuit;
a first lookup table circuit; and
a power manager configured to:
   detect an inactive state in the first circuit in an IC;
   generate an indication of a first duration of the inactive state of the first circuit;
   access a first lookup table to obtain a first low-power mode (LPM) identifier based on the first duration of the inactive state of the first circuit; and
   cause the first circuit to enter a first LPM identified by the first LPM identifier.

2. The IC of clause 1, the power manager comprising a power manager circuit further configured to:
access the first lookup table to obtain the first LPM identifier based on an indication of a frequency of a clock signal in the first circuit.

3. The IC of clause 1 or clause 2, the power manager comprising a power manager circuit configured to:
access the first lookup table to obtain the first LPM identifier based on an indication of a frequency of a memory interface of a memory coupled to the first circuit.

4. The IC of any of clause 1 to clause 3, further comprising a second circuit in the IC, the power manager further configured to:
detect an inactive state in the second circuit;
generate an indication of a second duration of the inactive state of the second circuit;
access a second lookup table to obtain a second LPM identifier for the second circuit based on the second duration of the inactive state of the second circuit; and
cause the second circuit to enter a second LPM identified by the second LPM identifier.

5. The IC of any of clause 1 to clause 3, the power manager further configured to:
access the first lookup table to obtain the first LPM identifier based on a first circuit identifier to identify the first circuit.

6. The IC of clause 5, the power manager further configured to:
detect an inactive state in a second circuit in the IC;
generate an indication of a duration of the inactive state of the second circuit and a second circuit identifier to identify the second circuit;
access the first lookup table to obtain a second LPM identifier for the second circuit based on the second circuit identifier and the duration of the inactive state of the second circuit; and
cause the second circuit to enter a second LPM identified by the second LPM identifier.

7. The IC of any of clause 1 to clause 6, the power manager configured to:
store a plurality of LPM identifiers comprising the first LPM identifier in the first lookup table; and
index the plurality of LPM identifiers according to corresponding ranges of durations,
wherein:
   the first LPM identifier is obtained in response to the first duration of the inactive state of the first circuit being within the range of durations corresponding to the first LPM identifier.

8. The IC of any of clause 1 to clause 7, wherein:
the first LPM identifier is one of a plurality of LPM identifiers for a plurality of first LPMs for the first circuit; and
each first LPM of the plurality of first LPMs has a rate of power consumption unique among rates of power consumption of the plurality of first LPMs.

9. The IC of clause 8, wherein:
the first LPM identified by the first LPM identifier provides a greatest net power savings among the plurality of first LPMs for the first duration of the inactive state.

10. The IC of clause 7, wherein the power manager is further configured to index the plurality of LPM identifiers based on a frequency of a clock signal of the first circuit.

11. The IC of any of clause 1 to clause 10 integrated into a device selected from the group consisting of: a set-top box; an entertainment unit; a navigation device; a communications device; a fixed location data unit; a mobile location data unit; a global positioning system (GPS) device; a mobile phone; a cellular phone; a smartphone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; and a vehicle component.

12. A method of reducing power consumption in an integrated circuit (IC), the method comprising:
detecting an inactive state of a first circuit in an IC;
generating an indication of a first duration of the inactive state of the first circuit;
accessing a first lookup table to obtain a first low-power mode (LPM) identifier of an optimal LPM for the first circuit based on the first duration of the inactive state of the first circuit; and
causing, by the power manager, the first circuit to enter a first LPM identified by the first LPM identifier.

13. The method of clause 12, further comprising:
accessing the first lookup table to obtain the first LPM identifier based on an indication of a frequency of a clock signal in the first circuit.

14. The method of clause 12 or clause 13, further comprising:
accessing the first lookup table to obtain the first LPM identifier based on an indication of a frequency of a memory interface of a memory coupled to the first circuit.

15. The method of any of clause 12 to clause 14, further comprising:
detecting an inactive state in a second circuit in the IC;
generating an indication of a second duration of the inactive state of the second circuit;
accessing a second lookup table to obtain a second LPM identifier for the second circuit based on the second duration of the inactive state of the second circuit; and
causing the second circuit to enter a second LPM identified by the second LPM identifier.

16. The method of any of clause 12 to clause 14, further comprising:
accessing the first lookup table to obtain the first LPM identifier based on a first circuit identifier to identify the first circuit.

17. The method of clause 16, further comprising:
detecting an inactive state in a second circuit in the IC;
generating an indication of a second duration of the inactive state of the second circuit and a second circuit identifier to identify the second circuit;
accessing the first lookup table to obtain a second LPM identifier for the second circuit based on the second circuit identifier and the second duration; and
causing the second circuit to enter a second LPM identified by the second LPM identifier.

18. The method of any of clause 12 to clause 17, further comprising:
storing a plurality of LPM identifiers comprising the first LPM identifier in the first lookup table;
indexing the plurality of LPM identifiers according to corresponding ranges of durations; and
obtaining the first LPM identifier in response to the first duration of the inactive state of the first circuit being within the range of durations corresponding to the first LPM identifier.

19. The method of clause 18, wherein:
the range of durations corresponding to the first LPM identifier is indicated by one of a maximum duration and a minimum duration; and
obtaining the first LPM identifier further comprises comparing the first duration to the one of the maximum duration and the minimum duration.

20. The method of clause 19, further comprising:
determining a minimum duration of the range of durations corresponding to the first LPM identifier based on a duration threshold between a first LPM identified by the first LPM identifier and a second LPM identified by a second LPM identifier.

What is claimed is:

1. An integrated circuit (IC) comprising:
a first circuit;
a first lookup table circuit; and
a power manager configured to:
detect an inactive state in the first circuit in an IC;
generate an indication of a first duration of the inactive state of the first circuit;
access a first lookup table to obtain a first low-power mode (LPM) identifier based on the first duration of the inactive state of the first circuit; and
cause the first circuit to enter a first LPM identified by the first LPM identifier.

2. The IC of claim 1, the power manager comprising a power manager circuit further configured to:
access the first lookup table to obtain the first LPM identifier based on an indication of a frequency of a clock signal in the first circuit.

3. The IC of claim 2, the power manager comprising a power manager circuit configured to:
access the first lookup table to obtain the first LPM identifier based on an indication of a frequency of a memory interface of a memory coupled to the first circuit.

4. The IC of claim 1, further comprising a second circuit in the IC, the power manager further configured to:
detect an inactive state in the second circuit;
generate an indication of a second duration of the inactive state of the second circuit;
access a second lookup table to obtain a second LPM identifier for the second circuit based on the second duration of the inactive state of the second circuit; and
cause the second circuit to enter a second LPM identified by the second LPM identifier.

5. The IC of claim 1, the power manager further configured to:
access the first lookup table to obtain the first LPM identifier based on a first circuit identifier to identify the first circuit.

6. The IC of claim 5, the power manager further configured to:
detect an inactive state in a second circuit in the IC;
generate an indication of a duration of the inactive state of the second circuit and a second circuit identifier to identify the second circuit;
access the first lookup table to obtain a second LPM identifier for the second circuit based on the second circuit identifier and the duration of the inactive state of the second circuit; and
cause the second circuit to enter a second LPM identified by the second LPM identifier.

7. The IC of claim 1, the power manager configured to:
store a plurality of LPM identifiers comprising the first LPM identifier in the first lookup table; and
index the plurality of LPM identifiers according to corresponding ranges of durations,
wherein:
the first LPM identifier is obtained in response to the first duration of the inactive state of the first circuit being within the range of durations corresponding to the first LPM identifier.

8. The IC of claim 1, wherein:
the first LPM identifier is one of a plurality of LPM identifiers for a plurality of first LPMs for the first circuit; and
each first LPM of the plurality of first LPMs has a rate of power consumption unique among rates of power consumption of the plurality of first LPMs.

9. The IC of claim 8, wherein:
the first LPM identified by the first LPM identifier provides a greatest net power savings among the plurality of first LPMs for the first duration of the inactive state.

10. The IC of claim 7, wherein the power manager is further configured to index the plurality of LPM identifiers based on a frequency of a clock signal of the first circuit.

11. The IC of claim 1 integrated into a device selected from the group consisting of: a set-top box; an entertainment unit; a navigation device; a communications device; a fixed location data unit; a mobile location data unit; a global positioning system (GPS) device; a mobile phone; a cellular phone; a smartphone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; and a vehicle component.

12. A method of reducing power consumption in an integrated circuit (IC), the method comprising:
detecting an inactive state of a first circuit in an IC;
generating an indication of a first duration of the inactive state of the first circuit;
accessing a first lookup table to obtain a first low-power mode (LPM) identifier of an optimal LPM for the first circuit based on the first duration of the inactive state of the first circuit; and
causing, by the power manager, the first circuit to enter a first LPM identified by the first LPM identifier.

13. The method of claim 12, further comprising:
accessing the first lookup table to obtain the first LPM identifier based on an indication of a frequency of a clock signal in the first circuit.

14. The method of claim 13, further comprising:
accessing the first lookup table to obtain the first LPM identifier based on an indication of a frequency of a memory interface of a memory coupled to the first circuit.

15. The method of claim 12, further comprising:
detecting an inactive state in a second circuit in the IC;
generating an indication of a second duration of the inactive state of the second circuit;
accessing a second lookup table to obtain a second LPM identifier for the second circuit based on the second duration of the inactive state of the second circuit; and
causing the second circuit to enter a second LPM identified by the second LPM identifier.

16. The method of claim 12, further comprising:
accessing the first lookup table to obtain the first LPM identifier based on a first circuit identifier to identify the first circuit.

17. The method of claim 16, further comprising:
detecting an inactive state in a second circuit in the IC;
generating an indication of a second duration of the inactive state of the second circuit and a second circuit identifier to identify the second circuit;
accessing the first lookup table to obtain a second LPM identifier for the second circuit based on the second circuit identifier and the second duration; and
causing the second circuit to enter a second LPM identified by the second LPM identifier.

18. The method of claim 12, further comprising:
storing a plurality of LPM identifiers comprising the first LPM identifier in the first lookup table;
indexing the plurality of LPM identifiers according to corresponding ranges of durations; and
obtaining the first LPM identifier in response to the first duration of the inactive state of the first circuit being within the range of durations corresponding to the first LPM identifier.

19. The method of claim 18, wherein:
the range of durations corresponding to the first LPM identifier is indicated by one of a maximum duration and a minimum duration; and
obtaining the first LPM identifier further comprises comparing the first duration to the one of the maximum duration and the minimum duration.

20. The method of claim 19, further comprising:
determining a minimum duration of the range of durations corresponding to the first LPM identifier based on a duration threshold between a first LPM identified by the first LPM identifier and a second LPM identified by a second LPM identifier.
